(19) United States
(12) Patent Application Publication
(10) Pub. No.: US 2026/0119386 A1
(43) Pub. Date: Apr. 30, 2026

(54) STOCHASTIC SAMPLING OF MEMORY OPERATIONS AT A PROCESSING UNIT

(71) Applicant: ADVANCED MICRO DEVICES, INC., Santa Clara, CA (US)

(72) Inventors: Joseph L. Greathouse, Austin, TX (US); Brian Emberling, Palo Alto, CA (US); Nicholas Curtis, Colchester, CT (US); Rene Willibrordus van Oostrum, Austin, TX (US)

(21) Appl. No.: 18/896,028

(22) Filed: Sep. 25, 2024

(51) Int. Cl. G06F 12/02; G06F 9/30

(52) U.S. Cl. CPC G06F 12/0223; G06F 9/30058; G06F 2212/251

(57) ABSTRACT

During execution of software a processing unit issues asynchronous operations such that there are multiple asynchronous operations, such as memory operations, in flight (that is, pending execution completion) from a single set of instructions, such as a wavefront or warp. In some cases, the processing unit executes other operations while the multiple asynchronous operations are pending. Performance monitor circuitry records information, such as asynchronous operation count information, register file scoreboard information, and the like, that allows a software engineer to identify which of a plurality of asynchronous operations caused a stall.

### BACKGROUND

Modern processing systems are often called upon to execute complex software, such as machine learning software, game software, and virtual reality software. The performance of such software sometimes depends on the configuration of the hardware of the processing system, and how that hardware interacts with the configuration and structure of the software. Thus, for example, the performance of a given piece of software is sometimes improved by changing the order in which instructions are issued by the software, by executing particular portions of the software in parallel at different processing units of the processing system, and the like. However, the particular changes to improve the software sometimes depend on how the software interacts with the hardware of the processing system and are therefore difficult to identify without executing the software with the processing system hardware. Accordingly, during software development, a software engineer sometimes executes a version of the software, analyzes the software performance (e.g., using one or more software analysis tools), and modifies the software based on the analysis. To assist in this process, some processing systems include performance monitor circuitry that records performance data representing different performance features of the software during execution. The software engineer employs the performance data in the analysis to determine how the software can be improved. However, it is difficult with conventional performance monitor circuitry to identify some aspects of the software that could be used to improve software performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing unit that employs performance monitor circuitry to record performance information indicating which of a plurality of pending memory operations caused a stall at a processing unit in accordance with some embodiments.

FIG. 2 is a block diagram illustrating an example of the processing unit of FIG. 1 recording performance information indicating which of a plurality of pending memory operations caused a stall at a processing unit in accordance with some embodiments.

FIG. 3 is a block diagram illustrating another example of the processing unit of FIG. 1 recording performance information indicating which of a plurality of pending memory operations caused a stall at a processing unit in accordance with some embodiments.

FIG. 4 is a block diagram of a processing unit that employs performance monitor circuitry to record register file scoreboard information indicating which of a plurality of pending memory operations caused a stall at a processing unit in accordance with some embodiments.

FIG. 5 is a block diagram incorporating the processing unit of FIG. 1 or the processing unit of FIG. 2 to generate performance information for software engineering in accordance with some embodiments.

### DETAILED DESCRIPTION

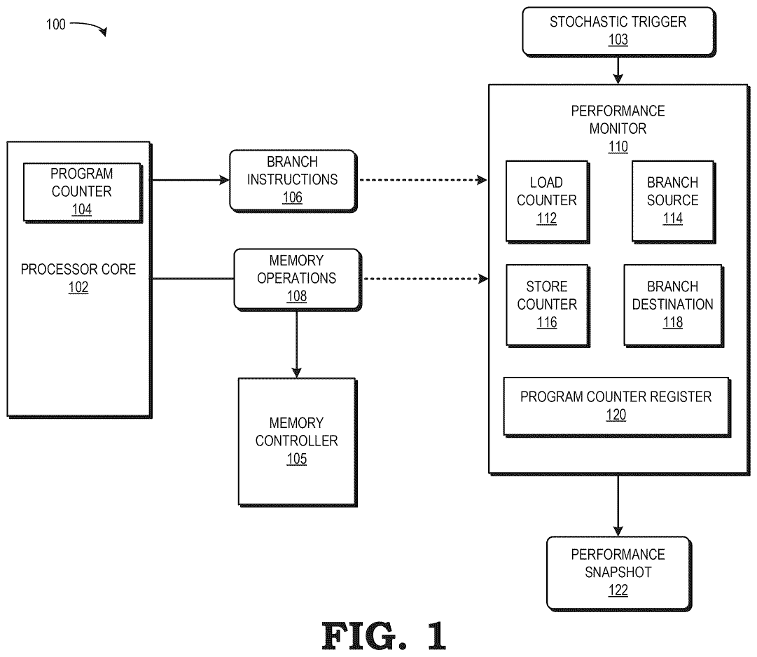

During execution of software a processing unit (e.g., a GPU) issues asynchronous operations such that there are multiple asynchronous operations, such as memory operations, in flight (that is, pending execution completion) from a single set of instructions, such as a wavefront or warp. In some cases, the processing unit executes other operations while the multiple asynchronous operations are pending. In these cases, it is difficult to identify which of the multiple asynchronous operations caused a stall at the processing unit that negatively impacted software performance. This difficulty, in turn, renders it difficult for a software engineer to adjust the software to mitigate or avoid the stall. FIGS. 1-5 illustrate techniques for performance monitor circuitry to record information, such as asynchronous operation count information, register file scoreboard information, and the like, that allows a software engineer to identify which of a plurality of asynchronous operations caused a stall, thus improving performance of the software at the processing unit.

To illustrate via an example, processing units sometimes employ a stochastic sampling approach to record performance information. Under this approach, in response to an interrupt the processing unit records performance information, such as program counter information, for an executing wavefront. The performance information is recorded to a data structure referred to as a performance snapshot. The interrupt is generated every N cycles (or every N instructions), wherein N is a programmable value. The performance snapshots thus provide stochastic views of how the wavefront is interacting with the processing unit hardware. However, with conventional stochastic sampling approaches, it is in some cases difficult to identify a particular operation that caused a stall at the processing unit.

For example, in some cases a wavefront issues a plurality of memory loads, and issues other instructions to be executed while the memory loads are being executed. Only at some later point in time, when the results of those loads are needed, does the software instruct the wavefront to issue a waiting (also referred to as a “waitcnt”) instruction that causes the wavefront to stall until the memory access has completed. This separation of memory operation from the wait-for-memory-to-complete operation allows the software to hide some of the latency of the memory access by performing other unrelated work. However, if one of the memory operations causes a stall at the processing unit, it is difficult to identify, using conventional stochastic performance sampling techniques, which of the plurality of memory operations caused the stall. For example, if the performance snapshot triggered on the waitcnt instruction, conventional techniques associate the stall with the waitcnt instruction itself, and do not indicate which of the plurality of memory instructions caused the stall. This in turn reduces the utility of the performance snapshot in software analysis.

Using the techniques disclosed herein, a processing unit records, in response to a stochastic trigger such as an interrupt, performance information that indicates which of a plurality of asynchronous operations caused a stall at a processing unit. In some embodiments, the processing unit records count information, such as a count of pending asynchronous operations. In other embodiments, the processing unit records register file scoreboard information in response to the stochastic trigger, wherein the register file scoreboard information indicates which asynchronous operations are associated with operations that have been assigned registers in a register file. In still other embodiments, the processing unit records branch source and destination information in response to the stochastic trigger. During analysis of a stall, a software engineer or automated software tool employs the count information, the register file scoreboard information, the branch information, or any combination thereof, to “walk back” from a waiting instruction to the asynchronous operation that caused the stall. Thus, using the techniques described herein, a processing unit records information that allows for improved analysis of software to be executed at a processor, and thus improves overall processing efficiency at the processing unit.

FIG. 1 illustrates a processing unit 100 that is generally configured to generate and store performance information indicating which of a plurality of pending asynchronous operations caused a stall at a processing unit in accordance with some embodiments. In at least some embodiments, the processing unit 100 is a processing unit that includes specially designed and configured hardware to carry out special-purpose operations on behalf of an electronic device. Thus, for purposes of description, the processing unit 100 is described with respect to an example embodiment wherein the processing unit 100 is a graphics processing unit (GPU) that executes graphics or other parallel processing operations in response to commands received from a central processing unit (CPU, not shown at FIG. 1). Accordingly, in various embodiments, the processing unit 100 is part of any one of a number of electronic devices that employ a GPU, such as a server (or set of servers), a desktop computer, a laptop computer, a game console, a smartphone, and the like. Furthermore, in other embodiments the processing unit 100 is a different kind of processing unit, such as a parallel processor vector processor, general-purpose GPU (GPGPU), non-scalar processor, highly-parallel processor, artificial intelligence (AI) processor, inference engine, machine learning processor, other multithreaded processing unit, and the like.

The processing unit 100 is generally configured to execute sets of instructions to carry out tasks, such as graphics related tasks, on behalf of an electronic device. To support execution of instructions, the processing unit includes one or more processor cores, such as processor core 102, that execute instructions concurrently or in parallel. For example, the processing unit 100 executes instructions from one or more graphics pipelines using a plurality of processor cores to render one or more graphics objects. A graphics pipeline includes, for example, one or more steps, stages, or instructions to be performed by the processing unit 100 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores of processing unit 100 in order to render one or more graphics objects for a scene. For simplicity, FIG. 1 illustrates a single processor core 102, but it will be appreciated that in other embodiments the processing unit 100 includes multiple processor cores.

In implementations, the one or more processor cores of processing unit 100 each operate as a compute unit configured to perform one or more operations for one or more instructions received by processing unit 100. These compute units each include one or more single instruction, multiple data (SIMD) units that perform the same operation on different data sets to produce one or more results. For example, in some embodiments processing unit 100 includes one or more processor cores (e.g., processor core 102) each functioning as a compute unit that includes one or more SIMD units to perform operations for one or more instructions from a graphics pipeline.

To facilitate one or compute units performing operations for instructions from a graphics pipeline, processing unit 100 includes one or more command processors (not shown for clarity). Such command processors, for example, include hardware-based circuitry, software-based circuitry, or both configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. In at least some embodiments, the command processors organize the instructions into groups (also referred to as sets) of threads that sometimes execute similar instructions or use similar sets of resources of the processing unit 100 and are typically scheduled together for execution at the one or more processor cores. Such groups are referred to herein as wavefronts, but in some cases are referred to as warps.

To identify the position of a particular instruction in a wavefront, the processor core 102 includes a program counter 104 that is configured to store the memory address of the next instruction to be executed in the wavefront. That is, the value stored at the program counter 104 indicates the next instruction to be executed in the current executed wavefront. Accordingly, as different instructions are executed, the processor core 102 updates the value stored at the program counter 104 to reflect the next instruction to be executed.

During execution of a wavefront, the processor core 102 generates asynchronous operations for execution, either at the core itself or at other circuitry of the processor core 102 or at other circuitry of the processing unit 100. Examples of these operations include memory operations 108 and branch instructions 106. Other examples of asynchronous operations applicable to the techniques described herein include atomic read-modify-write (RMW) operations, memory address translation requests (e.g., requests to translate virtual memory addresses to physical memory addresses), memory movement commands (e.g. commands for a direct memory access (DMA) engine, for a tensor memory accelerator, or a tensor data mover), asynchronous computation block commands (e.g., commands for a matrix multiplication core, tensor core, or matrix engine), ohand commands for an asynchronous memory-walking engine, such as a ray-tracing unit. For purposes of description, the processing unit 100 is described with respect to an example implementation where the operations for which performance information is recorded are memory operations and branch instructions, but it will be appreciated that in other embodiments, performance information for other types of asynchronous operations, including the examples listed above, are recorded and stored at a performance snapshot for subsequent analysis, as described further herein.

The memory operations 108 include operations to retrieve and store data at memory resources (not shown at FIG. 1) of the processing unit 100, such as internal dynamic random-access memory (DRAM), external DRAM, system memory, or any combination thereof. Examples of the memory operations 108 include load operations to load data from the memory resources, store operations to store data at the memory resources, and the like. The processor core 102 provides the memory operations 108 to a memory controller 105 for execution. In particular, the memory controller 105 includes circuitry to execute the memory operations 108, including one or more queues to store the memory operations and corresponding results, address translation circuitry (e.g., one or more translation look-aside buffers), cache controller and coherency circuitry, and circuitry to generate control signaling to load and store data from the memory resources.

The branch instructions 106 are instructions that cause a branch in the program flow of the wavefront or program executing at the processor core 102. Thus, the branch instructions 106 include conditional branch instructions, unconditional branch instructions, jump instructions, and the like. In some embodiments, the processing unit 100 includes circuitry (not shown) to support execution of the branch instructions, such as one or more branch target buffers, one or more arithmetic logic units configured to calculate branch addresses, execution units configured to test the conditionals for a conditional branch instruction, and the like. In some embodiments, each the branch instructions 106 includes a source address, indicating the source address of the branch instruction (and thus the position of the branch instruction in the program flow of a wavefront), and includes a destination address, indicating the address of the instruction that is targeted by the branch instruction (and thus the position of the targeted instruction in the program flow).

As noted above, in some cases it is useful, when developing software to be executed at the processing unit 100, to analyze how the software interacts with the processing unit's hardware and to modify the software based on the analysis.

Accordingly, to facilitate such analysis, the processing unit 100 includes performance monitor circuitry 110 (referred to herein as performance monitor 110 for simplicity). The performance monitor 110 is circuitry generally configured to record performance information stored at one or more counters, registers, and the like. In response to a stochastic trigger 103, the performance monitor 110 stores the recorded performance information at a performance snapshot 122. The stochastic trigger 103 is an interrupt or other event trigger that is configured to occur every N cycles of the processing unit 100 (that is, after every N cycles of a clock that controls at least some operations of the processing unit 100), every N instructions executed at the processor core 102, and the like, where N is an integer. In some embodiments, N is a programmable value. In some embodiments, N is randomized over time by software or circuitry.

The performance snapshot 122 is a file or other data structure that the performance monitor 110 stores at a memory (e.g., system memory, flash memory, a hard disc, latches, flip-flops, static RAM (SRAM), and the like). In some embodiments, a software analysis tool accesses the performance snapshot 122 to identify aspects of software execution at the processing unit 100. For example, in some embodiments the software analysis tool identifies stalls at the processing unit 100 by identifying cycles when the processor core 102 is not executing instructions (e.g., because it is awaiting execution of a memory operation by the memory controller 105), and further identifies instructions or operations that appear to lead to the stalls. This allows a software engineer to identify portions of a software program that have a relatively high negative impact on performance, and to adjust the software program to reduce that negative impact.

To facilitate identification of operations that lead to stalls, the performance monitor 110 includes a load counter 112, a store counter 116, a branch source register 114, a branch destination register 118, and a program counter register 120. The load counter 112 maintains a count of load operations pending execution at the memory controller 105. Thus, in response to the processor core 102 issuing a load operation, the performance monitor 110 increments the load counter 112 and, in response to the memory controller 105 completing execution of a load operation, the performance monitor 110 decrements the load counter 112. The store counter 116 is similar to the load counter 112 but stores a count of store operations that are pending execution. Thus, in response to the processor core 102 issuing a store operation, the performance monitor 110 increments the store counter 116 and, in response to the memory controller 105 completing execution of a store operation, the performance monitor 110 decrements the store counter 116.

The branch source register 114 stores the source address of the most recent branch instruction, and the branch destination register 118 stores the address of the most recent branch instruction. Thus, in response to the processor core 102 issuing a branch instruction, the performance monitor 110 stores the source address and destination address of the issued branch instruction to the branch source register 114 and the branch destination register 118 respectively. The program counter register 120 stores the value of the program counter 104 and is updated each time the program counter 104 is updated to reflect the most recent value of the program counter.

In response to each instance of the stochastic trigger 103, the performance monitor stores the data stored at the load counter 112, the branch source register 114, the store counter 116, the branch destination register 118, and the program counter register 120 to the performance snapshot 122. In some embodiments, the performance snapshot 122 is stored as part of performance profile for the software executing at the processing unit 100. That is, the performance profile stores different instances of the performance snapshot 122 over time, and thus represents a stochastic profile of how the executing software employs and interacts with the hardware of the processing unit 100. The performance profile is used, for example, by analysis software and a software engineer to identify portions of the software (e.g. individual instructions or sets of instructions) that are negatively impacting performance, and to adjust those portions of the software to improve performance of the software and the processing unit 100.

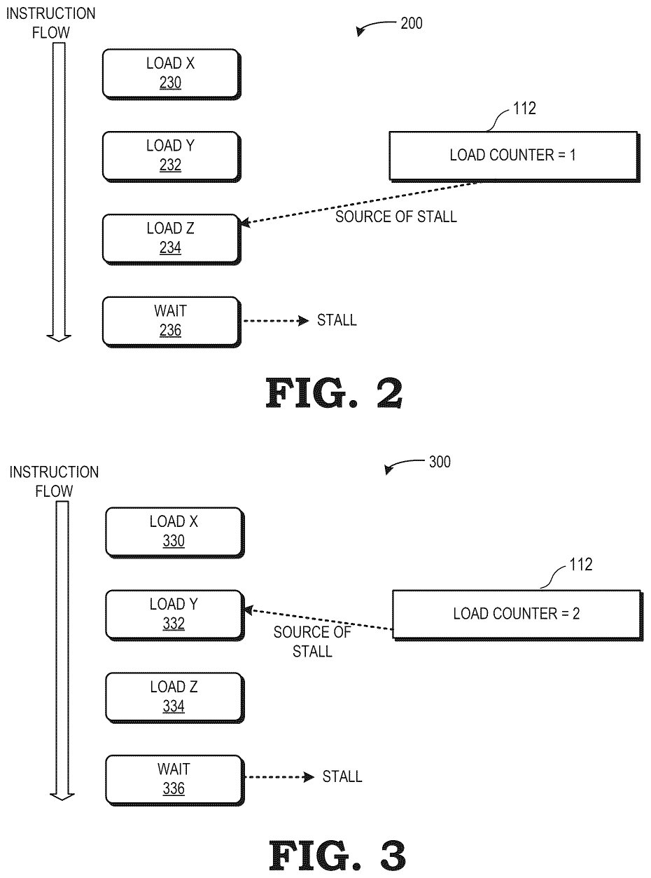

The data stored at the load counter 112 and the store counter 116 allow the software engineer to identify the particular memory operation that causes a stall at the processing unit 100. Examples are illustrated at FIGS. 2 and 3 in accordance with some embodiments. In the example of FIG. 2, the performance profile (based on one or more performance snapshots 122) indicates that the stochastic trigger 103 has triggered sampling of performance data for a wait instruction 236. This wait instruction is issued by the software to stall the processing unit 100 until a set of one or more memory operations is complete. Furthermore, analysis of the software (e.g., via a program listing, analysis tools, and the like) indicates that prior to the wait instruction 236, three load operations were issued by the processor core 102. These load operations are designated load operation 230, load operation 232 and load operation 234. These load operation 230-234 were issued in sequence, with the load operation 230 issued first and the load operation 234 issued last, prior to the wait instruction 236.

A conventional software analysis system has difficulty determining which of the load operations 230-234 caused the stall associated with the wait instruction 236.

However, by storing the value of the load counter 112 to the performance snapshot 122, the processing unit supports disambiguation of the load operation that resulted in the stall. Thus, in the example of FIG. 2, the snapshot 122 indicates that the load counter 112 stores a value of one. This indicates that it is the most recent load operation (relative to the wait instruction 236) that caused the stall. Thus, the analysis software and the software engineer are able to identify the load operation 234 as the source of the stall and, at least in some cases, adjust the software to eliminate the stall.

FIG. 3 illustrates another example of the performance snapshot 122 indicating which of a plurality of memory operations resulted in a stall. The example of FIG. 3 is similar to the example of FIG. 2, with the performance profile indicating a stall associated with a wait instruction 336, following a sequence of load operations designated load operation 330, load operation 332, and load operation 334. However, in the example of FIG. 2, the performance snapshot 122 indicates that the load counter stores a value of two. Accordingly, the analysis software and software engineer are able to identify the load 332 as the source of the stall. Thus, the examples of FIGS. 2 and 3 illustrate how the storing of the value of the load counter 112 allows the analysis software and software engineer to “walk back” in an instruction sequence from a stall condition to the memory operation that caused the stall condition.

Returning to FIG. 1, the data stored at the store counter 116, the branch source register 114, and the branch destination register 118 support disambiguation of more complex sequences of instructions associated with a stall. For example, the data stored at the store counter 116, together with the data stored at the load counter 112, allows a software engineer to identify the source of a stall in an instruction sequence including both load and store instructions (or a sequence including only store instructions).

The branch source and branch destination addresses (stored at the branch source register 114 and the branch destination register 118, respectively) allow the software engineer to identify the memory operation that caused a stall when the memory operation is part of an instruction loop. For example, by employing the last branch's source and the last branch's destination, the profiler software is able to identify the program counter value the of last branch's destination, and then identify the previous instruction was the last branch's source and continue its walk backwards in the instruction sequence. In some embodiments, the performance monitor 110 saves more than a single last branch-to/branch-from pair—that is, stores the branch source and destination information for multiple branch instructions, and transfers this information to the performance snapshot 122, thus supporting identification of source stalls in more complex sequences. In some embodiments, only the information for “taken” branches is stored, thereby reducing the overall amount of storage space used to store branch information.

In some embodiments, the processing unit 100 includes a mode that automatically turns branches into implicit wait (e.g., “waitcnt 0”) instructions. Stalling at branches until memory operations are complete, so that profiling software can precisely identify which memory operations yield slower memory accesses. If the memory operation and its usage are in the same basic block, the profiled information is accurate as if nothing changed. If memory operations are issued before a change in control flow, the control flow operations see extra latency (and cause application slowdown), but the profiler is able to identify which operation caused the latency.

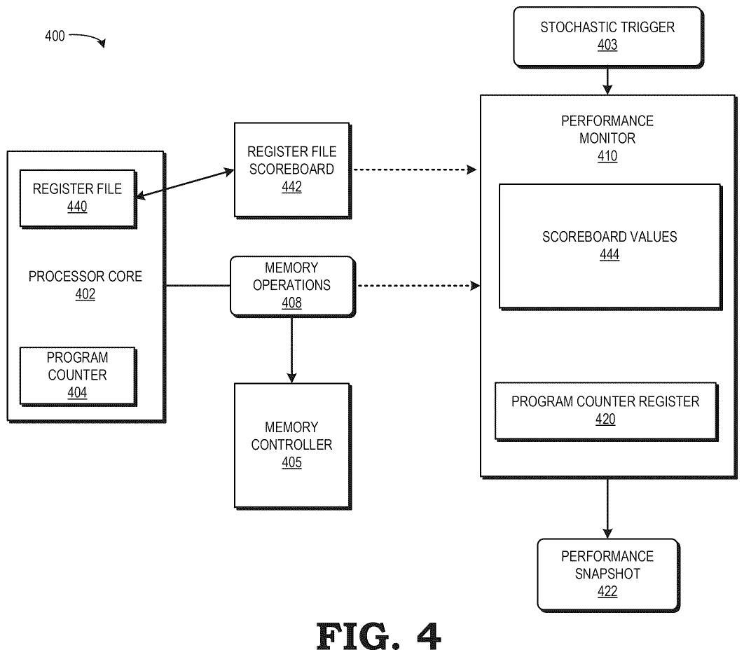

In some embodiments, a processing unit does not include the load counter 112 and the store counter 116, but instead includes a register scoreboard that identifies which registers of a register file have been assigned to instructions. By recording this register scoreboard information in a performance snapshot, a processing unit supports identification of memory operations that cause stalls. An example is illustrated at FIG. 4 in accordance with some embodiments.

FIG. 4 is a block diagram of a processing unit 400 in accordance with some embodiments. The processing unit 400 includes a processor core 402, having a program counter 404, that issues memory operations 408 to a memory controller 405, and further includes a performance monitor 410 having a program counter register 420 and that generates a performance snapshot 422. Each of these items operates similarly to the corresponding elements of FIG. 1 except as described further herein. In particular, the processor core 402 includes a register file 440 that includes a plurality of registers. The processor core 402 employs the plurality of registers to store data in order to execute instructions and uses a register file scoreboard 442 to indicate which registers of the register file 440 are assigned to a given instruction. For example, when the memory controller 405 completes a load operation, the processor core 402 assigns the load operation, or an instruction that triggered the load operation, to one of the registers 440, indicates the assignment in the register file scoreboard 442, and stores the data retrieved by the load operation at the assigned register.

The performance monitor 410 stores a set of scoreboard values 444 that indicate the register assignments at the register file scoreboard. In response to the stochastic trigger 403, the performance monitor 410 stores the scoreboard values 444 as part of the performance snapshot 422. A profiler or other software too is able to use the performance snapshot 422 (or a profile including multiple performance snapshots) to identify which of a plurality of memory operations caused a stall. For example, a wavefront stalls on an addition instruction that loads a value X into a register R1, a value Y into a register R2, and the result of the addition (X+Y) into a register R3. The performance snapshot 422 indicates that the processing unit 400 stalled at the addition instruction, and that R1 was assigned to the value X, but that R2 has not yet been assigned. Based on the performance snapshot 422, profiler software is able to determine that it is the load operation associated with loading the value Y to register R2 that caused the stall.

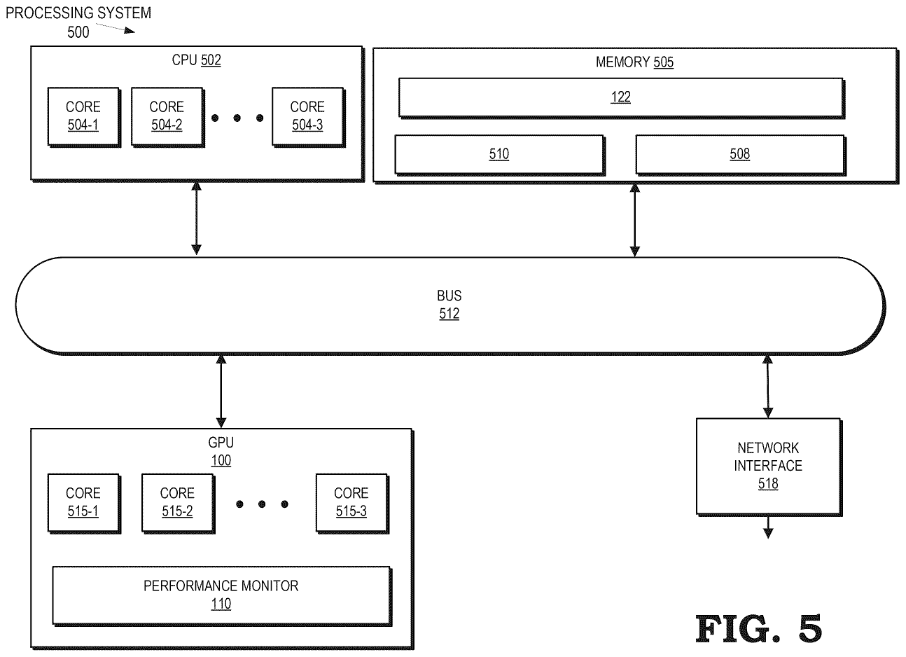

FIG. 5 illustrates an example of a processing system 500 that implements a performance monitor that records information indicating which of a plurality of memory operations is likely to have caused a stall in accordance with some implementations. In some implementations, processing system 500 and employs a processing unit 100 having a performance monitor 110 that records performance information as described herein. To this end, processing system 500 includes or has access to memory 505 or another storage component implemented using a non-transitory computer-readable medium, for example, a dynamic random-access memory (DRAM). However, in some implementations, memory 505 is implemented using other types of memory including, for example, static random-access memory (SRAM), nonvolatile RAM, non-volatile memory, and the like, or a combination thereof. According to some implementations, memory 505 includes an external memory implemented external to the processing units implemented in processing system 500. Processing system 500 also includes bus 512 to support communication between entities implemented in processing system 500, such as memory 505. Some implementations of processing system 500 include other buses, bridges, switches, routers, and the like, which are not shown in FIG. 5 in the interest of clarity.

The techniques described herein are, in different implementations, employed at processing unit 100. In other embodiments, the processing system 500 includes one or more, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof that include a performance monitor 110. The processing unit 100 renders graphics objects (e.g., sets of primitives) of a scene of a ray tracing context in a screen space (e.g., display space) to be displayed to produce values of pixels in the form of video frames, and the video frames are provided to a network interface 518 that communicates the video frames to the corresponding client devices via one or more networks. In some implementations, network interface 518 communicates with each client device via a respective network connection (not shown).

To render these graphics objects, the processing unit 100 includes a plurality of processor cores 515-1 to 515-3 that execute instructions concurrently or in parallel. For example, the processing unit 100 executes instructions from one or more graphics pipelines using a plurality of processor cores 515 to render one or more graphics objects. A graphics pipeline includes, for example, one or more steps, stages, or instructions to be performed by processing unit 100 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 515 of processing unit 100 in order to render one or more graphics objects for a scene.

In implementations, one or more processor cores 515 of processing unit 100 each operate as a compute unit configured to perform one or more operations for one or more instructions received by processing unit 100. These compute units each include one or more single instruction, multiple data (SIMD) units that perform the same operation on different data sets to produce one or more results. For example, processing unit 100 includes one or more processor cores 515 each functioning as a compute unit that includes one or more SIMD units to perform operations for one or more instructions from a graphics pipeline. The cores 515 are each configured to operate similarly to the processor core 102 of FIG. 1. To facilitate one or compute units performing operations for instructions from a graphics pipeline, processing unit 100 includes one or more command processors (not shown for clarity). Such command processors, for example, include hardware-based circuitry, software-based circuitry, or both configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 5 presents processing unit 100 as having three processor cores (515-1, 515-2, 515-3) representing an arbitrary number of cores; the number of processor cores 515 implemented in processing unit 100 is a matter of design choice. As such, in other implementations, processing unit 100 includes any number of processor cores 515. Some implementations of processing unit 100 are used for general-purpose computing. For example, processing unit 100 executes instructions such as program code 508 for one or more applications 510 stored in memory 505 and processing unit 100 stores information in the memory 505 such as the results of the executed instructions.

In some implementations, the processing unit 100 is a GPU configured to perform graphics operations. To facilitate the performance of such operations, each graphics core of processing unit 100 is associated with (e.g., configured to communicate with) a respective command processor configured to provide data (e.g., operations, operands, instructions, variables, register files) to one or more compute units of a graphics core necessary for, helpful for, or aiding in the performance of the operations for a respective set of instructions. Because each graphics core is associated with a respective command processor configured to provide data based on a respective set of instructions, the graphics cores are enabled to render different graphics objects and encode different portions of an image at different times. That is to say, two or more graphics cores are configured to concurrently render different graphics objects such that, for example, a first graphics core renders a first graphics object, and a second graphics core concurrently renders a second graphics object different from the first graphics object.

The processing unit 100 includes a performance monitor 110 that records performance information as described further herein. For example, in some embodiments the performance monitor 110 stores performance information including one or more of load counts, store counts, branch source information, branch destination information, and register scoreboard information. In response to a stochastic trigger such as an interrupt, the performance monitor stores the performance information to a performance snapshot 122. A profiler (e.g., a software tool) employs the performance snapshot 122 to identify which of a plurality of memory operations caused a stall at the processing system 500.

Processing system 500 also includes a central processing unit (CPU) 502 that is connected to bus 512 and communicates with the processing unit 100 and memory 505 via bus 512. CPU 502 includes a plurality of processor cores 504-1 to 504-3 that execute instructions concurrently or in parallel. Though in the example implementation illustrated in FIG. 5, three processor cores (504-1, 504-2, 504-3) are presented representing an arbitrary number of cores, the number of processor cores 504 implemented in the CPU 502 is a matter of design choice. As such, in other implementations, the CPU 502 can include any number of processor cores 504. In some implementations, the CPU 502 and processing unit 100 have an equal number of processor cores while in other implementations, the CPU 502 and processing unit 100 have differing numbers of processor cores. Processor cores 504 execute instructions such as program code 508 for one or more applications 510 stored in memory 505 and CPU 502 stores information in the memory 505 such as the results of the executed instructions. CPU 502 is also able to initiate graphics processing, including one or more encoding operations, by issuing commands (e.g., encoding commands, draw calls, and the like) to processing unit 100 via bus 512.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving a stochastic sampling trigger at a processing unit; and
in response to receiving the stochastic sampling trigger, recording, at the processing unit, performance information indicating which operation of a plurality of asynchronous operations caused a stall at the processing unit.

2. The method of claim 1, wherein the asynchronous operations include at least one of a memory operation, atomic read-modify-write (RMW) operations, memory address translation requests, memory movement commands, asynchronous computation block commands, and commands for an asynchronous memory-walking engine.

3. The method of claim 1, wherein the performance information includes a first count of memory operations of a first type.

4. The method of claim 3, wherein the performance information includes a second count of memory operations of a second type.

5. The method of claim 1, wherein the performance information includes branch information.

6. The method of claim 5, wherein the branch information includes branch source information for a most recent branch instruction.

7. The method of claim 5, wherein the branch information includes branch destination information for a most recent branch instruction.

8. The method of claim 1, wherein the performance information includes register scoreboard information to indicate which registers of the processing unit are assigned to a given instruction of the plurality of asynchronous operations.

9. The method of claim 1, further comprising:
stalling the processing unit in response to a branch instruction prior to receiving the stochastic sampling trigger.

10. A processing unit, comprising:
a memory controller configured to issue a plurality of memory operations; and
performance monitoring circuitry configured to:
in response to a stochastic sampling trigger, recording performance information indicating which operation of the plurality of memory operations caused a stall at the processing unit.

11. The processing unit of claim 10, wherein the performance information includes a first count of memory operations of a first type.

12. The processing unit of claim 11, wherein the performance information includes a second count of memory operations of a second type.

13. The processing unit of claim 10, wherein the performance information includes branch information.

14. The processing unit of claim 13, wherein the branch information includes branch source information for a most recent branch instruction.

15. The processing unit of claim 13, wherein the branch information includes branch destination information for a most recent branch instruction.

16. The processing unit of claim 10, wherein the performance information includes register scoreboard information to indicate which registers of the processing unit are assigned to a given instruction of the plurality of memory operations.

17. The processing unit of claim 10, further comprising:
stall circuitry configured to stall the processing unit in response to a branch instruction prior to receiving the stochastic sampling trigger.

18. A method, comprising:
receiving a stochastic sampling trigger at a processing unit; and
in response to receiving the stochastic sampling trigger, recording, at the processing unit, performance information including a first count of operations of a first type and a second count of operations of a second type.

19. The method of claim 18, wherein:
the first count of operations is of memory operations of the first type; and
the second count of operations is of memory operations of the second type.

20. The method of claim 18, wherein the performance information includes branch information.
